(19) United States
(12) Patent Application Publication
(10) Pub. No.: US 2012/0063146 A1
(43) Pub. Date: Mar. 15, 2012

(54) SPOT LIGHT SOURCE AND BULB-TYPE LIGHT SOURCE

(76) Inventors: Shinya Kawagoe, Osaka (JP); Naotaka Hashimoto, Osaka (JP); Toshiyasu Kojima, Osaka (JP); Masanori Higashi, Kyoto (JP)

(21) Appl. No.: 13/322,109

(22) PCT Filed: Oct. 29, 2010
(86) PCT No.: PCT/JP2010/006423

§ 371 Date: Nov. 22, 2011

(30) Foreign Application Priority Data
Nov. 6, 2009 (JP) 2009-255284

(51) Int. Cl. F21V 29/00

(52) U.S. Cl. 362/294

(57) ABSTRACT

In a spot light source 1 including a case 11, a heat radiator 12 and a light-emitter 18, the heat radiator 12 is formed to have a bowl shape including a bottom portion 12a and a side wall portion 12b extending from the peripheral edge of the bottom portion 12a, and the side wall portion 12b is made of light-transmissive ceramic. Light emitted by an LED element 18b of the light-emitter 18 is guided to the side wall portion 12b by a lens 18d so as to generate a leak light traveling sideways from the spot light source 1, which produces highly decorative effect.

### TECHNICAL FIELD

The present invention relates to spot light sources provided with light-emitting elements such as LEDs (Light Emitting Diodes), and bulb-type light sources.

### BACKGROUND ART

Halogen light bulbs with a reflection mirror are now common as spot light sources for spotlights in commercial facilities and residences, for example.

Meanwhile, the reduction of the power consumption and the extension of the lifetime are considered important in the technical field of lighting, and new technology of replacing conventional light bulbs with lighting devices with LEDs (hereinafter referred to as LED lighting devices) have been researched and developed. Halogen lamp bulbs with a reflection mirror are no exception. Many kinds of LED lighting devices with a reflection mirror have been proposed (For example, see Patent Literatures 1 and 2).

Generally, LEDs generate heat during the lighting, and the luminous efficiency decreases as the temperature thereof increases due to the heat generation. Considering the above, it is an important issue for the practical use of LED lighting devices that how to improve the heat radiation performance within the limitation on their sizes, namely the LED lighting devices should be attachable to conventional fixtures. To solve this issue, technology for adopting a metal reflection mirror in a LED lighting device and allowing the reflection mirror to also serve as a heat radiator has been proposed (For example, see Patent Literature 3). This technology improves the heat radiation performance of LED lighting devices within the size limitation.

### CITATION LIST

### Patent Literature

Patent Literature 1: Japanese Patent Application Publication No. 2007-317431
Patent Literature 2: Japanese Registered Utility Model No. 3153732
Patent Literature 3: Japanese Patent Application Publication No. 2006-202612

### SUMMARY OF INVENTION

### Technical Problem

It is common in a conventional halogen light bulb with a reflection mirror that a reflective film such as a metal vapor-deposited film or a dielectric multilayer film is formed on the internal circumferential surface of a bowl-shaped glass substrate of the reflection mirror. However, since a halogen light bulb is attached to the neck of the glass substrate with an adhesive agent, it is common that the reflective film is not formed on the surface of the neck. When such a halogen light bulb with a reflection mirror is lit, light is output not only from the open end of the reflection mirror, but also from the neck, on which the reflection film is not formed. Light from the neck is referred to as leak light. In some cases, such leak light is positively used in commercial facilities and the likes to endow “a sense of brightness” to the entire space.

In contrast, concerning the LED lighting device with a reflection mirror as described above, the reflection mirror is made of metal, and light is emitted only from the open end of the reflection mirror, and leak light is not generated. Such an LED lighting device is therefore not suitable as an alternative to conventional halogen light bulbs in the case of positively using leak light.

In view of the problem above, the present invention aims to provide a spot light source and a bulb-type light source which serves as a substitute for conventional halogen light bulbs in the case of positively using leak light.

### Solution to Problem

To achieve the aim described above, a spot light source pertaining to the present invention provides a spot light source that serves as a substitute for a halogen light bulb having a reflection mirror, comprising: a heat radiator being bowl-shaped and including a bottom portion and a side wall portion; a light-emitting element provided within the heat radiator on the bottom portion; an optical controller controlling light emitted by the light-emitting element; a case having a built-in circuit for lighting the light-emitting element; and a base supplying power to the built-in circuit, wherein the optical controller guides a portion of the light emitted by the light-emitting element to the side wall portion, and the side wall portion is light-transmissive.

### Advantageous Effects of Invention

With the stated structure, since the side wall portion is light-transmissive, it is possible to generate leak light traveling sideways from the spot light source and positively use the leak light.

In the stated structure, it is preferable that the side wall portion is made of ceramic. In particular, the ceramic may contain primarily one or more constituents selected from the group consisting of silicon carbide, aluminum nitride, sapphire, alumina, beryllia, titania, yttria, silicon nitride, boron nitride, zirconia, magnesia and silica.

When the side wall portion contains a rare earth element in a polycrystalline state and changes a color of the light from the light-emitting element, leak light in a desired color can be generated.

Also, when a silicon carbide film is formed on an external circumferential surface of the side wall portion, the film improves the heat radiation efficiency of the heat radiator, since silicon carbide has a high heat conductivity.

The side wall portion may be made of a resin material.

Also, by integrating the bottom portion and the side wall portion in one piece, it is possible to save the trouble of assembling the spot light source, and improve the degree of accuracy in assembling the optical units.

A bulb-type light source pertaining to the present invention is a bulb-type light source that serves as a substitute for a halogen light bulb having a reflection mirror, comprising: a heat radiator being bowl-shaped and including a bottom portion and a side wall portion; a light-emitting element provided within the heat radiator on the bottom portion; an optical controller controlling light emitted by the light-emitting element; a case having a built-in circuit for lighting the light-emitting element; and a base supplying power to the built-in circuit, wherein the optical controller guides a portion of the light emitted by the light-emitting element to the side wall portion, and the side wall portion is made of ceramic containing a rare earth element in a polycrystalline state, and changes a color of the light from the light-emitting element.

With the stated structure, the color of the side wall portion changes depending on whether the light is on or off, and achieves highly decorative effect. Also in this stated structure, it is preferable that the side wall portion is made of ceramic. In particular, the ceramic may contain primarily one or more constituents selected from the group consisting of silicon carbide, aluminum nitride, sapphire, alumina, beryllia, titania, yttria, silicon nitride, boron nitride, zirconia, magnesia and silica.

### BRIEF DESCRIPTION OF DRAWINGS

FIG. 1 is a partially cutaway view showing the structure of a spot light source pertaining to an embodiment of the present invention.

FIG. 2 is a drawing illustrating a total light transmission of a side wall portion 12b.

FIG. 3 is a cross-sectional perspective view showing the structure of a spot light source provided with three LED elements and a cannonball-shaped lens.

FIGS. 4A-4C are plan views showing examples of the positioning of LED elements of a spot light source 3, which respectively show the cases in which the number of the LED elements is three, four and six.

FIG. 5 is a cross-sectional perspective view showing the structure of a spot light source provided with a single LED element and a reflective lens.

FIG. 6 is a cross-sectional perspective view showing the structure of a spot light source provided with a single LED element and a reflective lens.

FIG. 7 is perspective view showing the appearance of a reflective lens 39.

FIG. 8 is a cross-sectional perspective view showing the structure of a spot light source provided with three LED elements and three reflective lenses.

FIG. 9 is a cross-sectional perspective view showing the structure of a spot light source provided with three LED elements and three reflective lenses.

FIGS. 10A and 10B are perspective views showing the appearances of reflective lenses 43 and 44, FIG. 10A showing the reflective lens 43, and FIG. 10B showing the reflective lens 44.

FIG. 11 is a cross-sectional perspective view showing the structure of a spot light source provided with a single LED element and a convex lens.

FIG. 12 is a cross-sectional perspective view showing the structure of a spot light source provided with three LED elements and a convex lens.

FIG. 13 is a cross-sectional perspective view showing the structure of a spot light source provided with a single LED element and a Fresnel lens.

FIG. 14 is a cross-sectional perspective view showing the structure of a spot light source provided with three LED elements and a Fresnel lens.

FIG. 15 is a perspective view showing the appearance of a Fresnel lens 46.

FIG. 16 is a cross-sectional perspective view showing the structure of a spot light source provided with a single LED element and the combination of a cannonball-shaped lens and a convex lens.

FIG. 17 is a cross-sectional perspective view showing the structure of a spot light source provided with three LED elements and the combination of a cannonball-shaped lens and a convex lens.

FIG. 18 is a cross-sectional perspective view showing the structure of a spot light source provided with a single LED element and the combination of a cannonball-shaped lens and a Fresnel lens.

FIG. 19 is a cross-sectional perspective view showing the structure of a spot light source provided with a single LED element and the combination of a cannonball-shaped lens and a Fresnel lens.

FIG. 20 is a cross-sectional perspective view showing the structure of a spot light source provided with the combination of a reflective lens and a convex lens.

FIG. 21 is a cross-sectional perspective view showing the structure of a spot light source provided with a lens having a one-piece structure in which a reflective lens and a convex lens are integrated.

FIG. 22 is a cross-sectional perspective view showing the structure of a spot light source provided with the combination of three LED elements and the combination of a reflective lens and a convex lens.

FIG. 23 is a cross-sectional perspective view showing the structure of a spot light source provided with three LED elements and a lens having a one-piece structure in which a reflective lens and a convex lens are integrated.

FIG. 24 is a cross-sectional perspective view showing the structure of a spot light source provided with a single LED element, a reflective lens, and a Fresnel lens.

FIG. 25 is a cross-sectional perspective view showing the structure of a spot light source provided with three LED elements, a reflective lens, and a Fresnel lens.

FIG. 26 is a partially cutaway view showing the structure of a spot light source provided with an E type base.

### DESCRIPTION OF EMBODIMENTS

The following explains in detail an Embodiment of the present invention, with reference to the drawings.

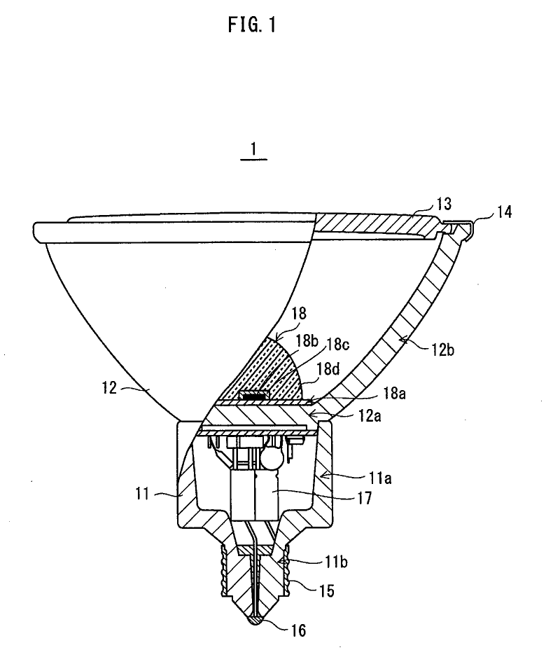

FIG. 1 is a partially cutaway view showing the structure of a spot light source pertaining to the embodiment of the present invention.

A spot light source 1 includes, as principal components, a case 11, a heat radiator 12 and a light-emitter 18. First, an overall structure including these components is explained, and then a detailed structure of the heat radiator 12 is explained next.

### <Overall Structure>

The case 11 is made of an insulating material such as ceramic, and includes a cylindrical portion 11a and a protruding portion 11b extending from one end of the cylindrical portion 11a. A lighting circuit 17 is housed in the internal space of the cylindrical portion 11a. A shell 15, which is made of metal, is provided on the external circumferential surface of the protruding portion 11b, and an eyelet 16, which is made of metal, is provided at the tip of the protruding portion 11b. The shell 15 and the eyelet 16 are each connected to the lighting circuit 17, and serve as a power supply terminal for receiving power from an external power source.

The heat radiator 12 includes a bottom portion 12a and a side wall portion 12b extending from the peripheral edge of the bottom portion 12a, and is formed to have a bowl shape. A light-emitter 18 is fixed to the bottom portion 12a of the heat radiator with a heat-conductive adhesive agent. A front glass 13 is attached to the opening of the heat radiator 12 with a metal part 14. The case 11 is fixed to the external surface of the bottom portion 12a of the heat radiator. The side wall portion 12b of the heat radiator 12 is made of a light-transmissive material. The internal circumferential surface of the heat radiator 12 is a half mirror, and the heat radiator 12 also serves as a reflection mirror. The size of the heat radiator 12 is similar to or smaller than conventional halogen light bulb with a reflection mirror. For example, when the light source is for replacing the halogen light bulb with a reflection mirror having an opening whose diameter is in the range from 50 mm to 70 mm, the diameter of the opening of the heat radiator 12 is to be in the range from 50 mm to 70 mm, or smaller. It is preferable that the thickness of the side wall portion 12b is in the range from 1 mm to 3 mm.

The light-emitter 18 includes a metal substrate 18a, an LED element 18b, a silicone resin member 18c and a lens 18d. The metal substrate 18a is formed by forming an insulating film, such as a resin film, on the upper surface of a metal substrate, such as copper, and forming a wiring pattern on the insulating film. The wiring pattern is connected to the lighting circuit 17 via wiring which is not depicted in the drawing. The LED element 18b is a blue light-emitting diode, and is mounted on the wiring pattern formed on the metal substrate 18a. The silicone resin member 18c is formed to encapsulate the LED element 18b, and yellow phosphor particles are dispersed in its silicone resin. The LED element 18b combined with the silicone resin member generates white light. The lens 18d is a cannonball-shaped lens made of a light-transmissive material such as resin, and is formed to encapsulate the silicone resin member 18c. The lens 18d serves as an optical controller. The light-emitter 18 is positioned such that the optical axis of the light-emitter 18 coincides with the central axis of the bowl-shaped heat radiator 12.

The spot light source 1, when used, is coupled with a socket installed in a commercial facility or the like. Light of the light-emitter 18 is output not only as spotlight from the opening of the heat radiator 12 via the front glass 13, but also as transmitted light from the side wall portion 12b of the heat radiator 12. Hence, the spot light source 1 brings “a sense of brightness” to the entire space of commercial facilities and the likes.

Heat generated by lighting of the LED element 18b is transmitted to the heat radiator 12 via the heat-conductive metal substrate 18a and the heat-conductive adhesive agent, and is therefore released effectively. This improves the luminous efficiency.

### <Detailed Structure of Heat Radiator>

The light-transmissive material used for forming the side wall portion 12b of the heat radiator 12 is, for example, ceramic consisting primarily of any one selected from silicon carbide (SiC), aluminum nitride (AlN), sapphire (Al₂O₃), sintered alumina (Al₂O₃), sintered beryllia (BeO), sintered calcia (CaO), sintered magnesia (MgO), sintered mullite (Al₂O₃—SiO₂), sintered titania (TiO₂), sintered yttria (Y₂O₃), molten silica (SiO₂), silicon nitride (Si₃N₄), boron nitride (BN), zirconia (ZrO₂) and steatite (MgO—SiO₂), or ceramic using a mixture of any of the materials listed above. Alternatively, the light-transmissive material may be resin. It should be noted here that ceramic is particularly preferable because it has a higher heat conductivity than resin and a higher light transmission than metal.

The side wall portion 12b of the heat radiator 12 contains a rare earth element, in order to enhance the design and decorative effect of the spot light source 1. The addition of a rare earth element suppresses the growth of crystal grains during the baking of ceramic, and prevents the ceramic wall from breaking easily due to the growth of the crystal grains. Moreover, the addition of a rare earth element increases the light transmission of the ceramic. This is because the rare earth element included in ceramic exhibit fluorescence, and thereby emit illumination light outward from the heat radiator 12.

For example, the ceramic contain one or more of the following rare earth elements: scandium (Sc); yttrium (Y); lanthanum (La); cerium (Ce); praseodymium (Pr); neodymium (Nd); samarium (Sm); promethium (Pm); europium (Eu); gadolinium (Gd); terbium (Tb); dysprosium (Dy); holmium (Ho); erbium (Er); thulium (Tm); ytterbium (Yb); and lutetium (Lu). It is possible to adjust the color of the transmission light by selecting rare earth elements to be added, and thereby further enhance the decorative effect of the spot light source.

Also, since the color of the light will be faint after the ceramic is baked at a high temperature and is amorphized, it is preferable that the ceramic is baked at a temperature not higher than the temperature for bringing the ceramic into the polycrystalline state. When resin is used for forming the heat radiator 12, the color of the transmission light can be adjusted by mixing a fluorescent material into the resin.

A thin layer of silicon carbide has been applied to the external circumferential surface of the heat radiator 12. The thickness is several micrometers, for example. Since silicon carbide has a high thermal conductivity, the stated structure improves the heat-radiation efficiency of the heat radiator 12.

It is preferable that the total light transmission of the side wall portion 12b is in the range from 5% to 80%, and is particularly preferable when it is within the range from 10% to 60%. Here, the total light transmission of the side wall portion 12b is defined as the ratio of the total flux under the condition where a lightproof cover is attached to the spot light source 1 to the total flux under the condition where the lightproof cover is not attached to the spot light source 1.

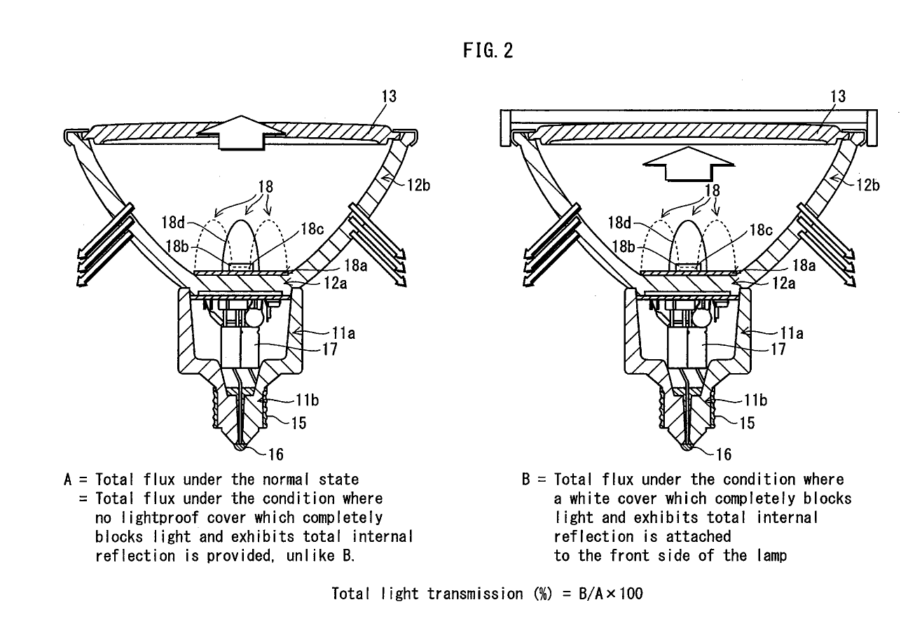

FIG. 2 is a drawing illustrating the total light transmission of the side wall portion 12b. As shown in FIG. 2, the total light transmission is defined as the ratio of the total flux B to the total flux A. The total flux B is the value measured under the condition where a white cover which completely blocks light and exhibits total internal reflection is attached to the front side of the lamp (i.e. the front side of the heat radiator) of the spot light source 1. The total flux A is the value measured under the condition where the cover is not attached. In the above case, both fluxes are measured by using an integrating photometer. To color the cover in white, barium sulfate (BaSO₄) may be applied to the surface of the cover, for example.

When the ceramic is used for forming the heat radiator 12, the total light transmission can be adjusted by adjusting the baking time, since the total light transmission of ceramics increases as the baking time increases. For example, when aluminum nitride is used as the ceramic material, the heat conductivity and the total light transmission can be increased by increasing the baking time.

Also note that the side wall portion 12b may be colored. Some conventional halogen light bulbs have a reflection mirror that utilizes a dichroic filter. When such a halogen light bulb is lit, the leak light would be in a particular color (e.g. red) in some cases. In view of this, it is possible to make the spot light source 1 a more practical alternative to such a halogen light bulb by coloring the side wall portion 12b to reproduce the particular color.

Since the lens 18d has a cannonball shape, the spot light source 1 allow more light to be leaked in the direction close to the light emission direction of the spot light source 1. Also, a portion of the emitted light can be guided to the side wall portion 12b of the heat radiator 12.

In conventional halogen light bulbs, distribution of light is controlled with a reflection mirror. In contrast, in the spot light source 1, distribution of light is controlled with the lens 18d. For this reason, in the spot light source 1, the direct light from the light-emitter 18 contributes greatly to the spotlight, but the reflection light from the internal circumferential surface of the heat radiator 12 contributes a little. Therefore, the brightness of the spotlight is not affected by forming the side wall portion 12b of the heat radiator 12 to be light-transmissive.

When ceramic is used for forming the heat radiator 12, the reflection light from the internal circumferential surface can be collected in the direction toward the front side of the spot light source 1 by forming the heat radiator 12 by casting and making the internal circumferential surface smooth. The amount of leak light from the side wall portion 12b can also be adjusted by adjusting the reflection rate.

### Modifications

Although the present invention is described above based on an embodiment, the present invention is not limited to the embodiment described above. For example, the following modifications may be adopted.

(1) Although Embodiment above describes a spot light source provided with a single LED element and a cannonball-shaped lens, the present invention is not limited to Embodiment as a matter of course. The spot light source may be provided with a plurality of LED elements and may be provided with a lens having a shape other than the cannonball shaped.

In addition to the cannonball-shaped lens, a reflective lens, a convex lens and a Fresnel lens may be used in the spot light source pertaining to the present invention. Also, a convex lens or a Fresnel lens may be combined with a cannonball-shaped lens, and a reflective lens and a Fresnel lens may be combined with a reflective lens.

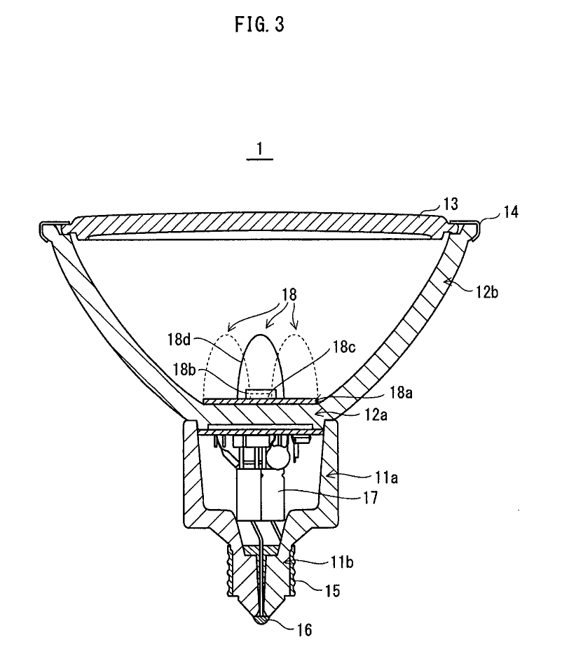

FIG. 3 is a cross-sectional perspective view showing the structure of a spot light source provided with three LED elements and a cannonball-shaped lens. As shown in FIG. 3, the spot light source 3 is a spot light source provided with three LED elements, and each of the three LED elements has a cannonball-shaped lens attached thereto.

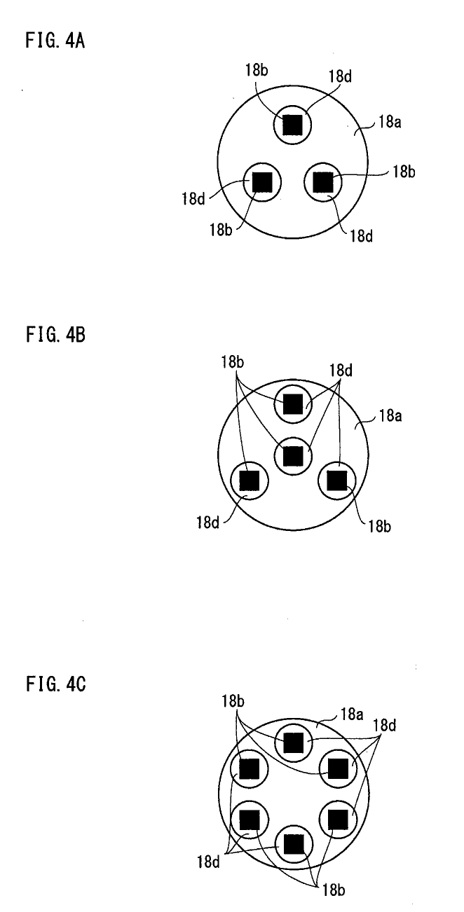

FIGS. 4A-4C are plan views showing examples of the positioning of LED elements of a spot light source 3, which respectively show the cases in which the number of the LED elements is three, four and six. In the spot light source 3, the three LED elements are positioned at the vertices of a regular triangle in order to prevent uneven light distribution (FIG. 4A).

A light source having such a structure is convenient because, when the spot light source has an E type base which is to be screwed into a socket, the light distribution does not change with rotation of the spot light source. When the number of LED elements is four or six, the same advantageous effects can be achieved by arranging the LED elements as shown in FIG. 4B and FIG. 4C.

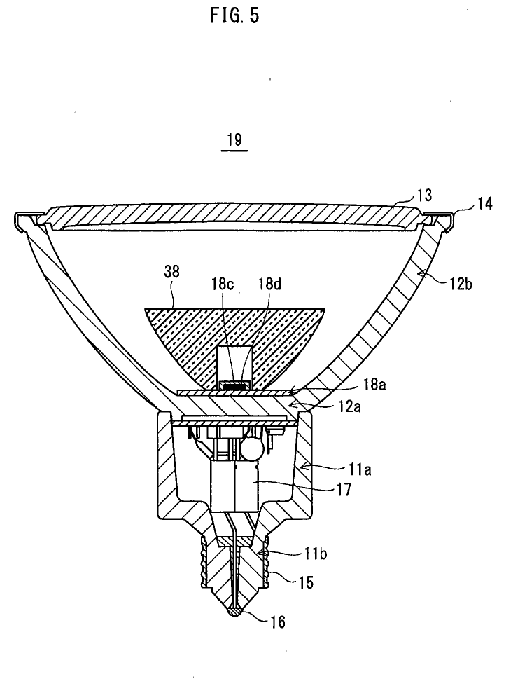

FIG. 5 is a cross-sectional perspective view showing the structure of a spot light source provided with a single LED element and a reflective lens. As shown in FIG. 5, the spot light source 5 is provided with a reflective lens 38 instead of a cannonball-shaped lens. The light emitted by the LED element 18b is guided mainly to the front side of the spot light source 5 by the reflective lens 38, whereas a portion of the light travels toward the side wall portion 12b, as leak light.

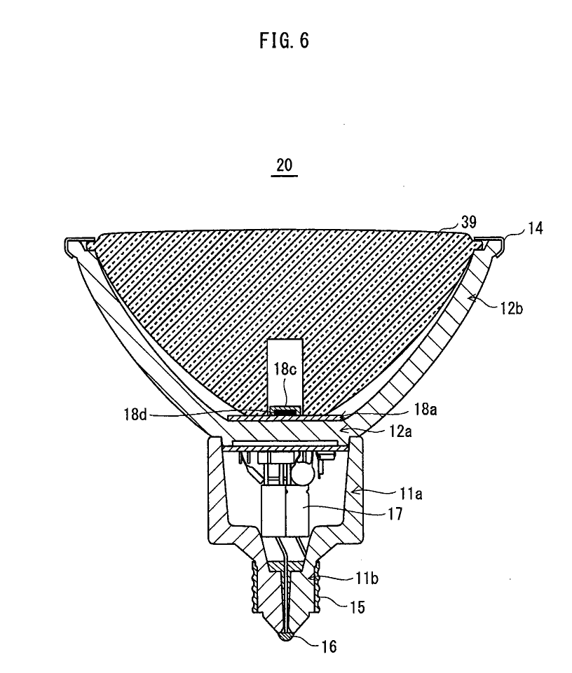

FIG. 6 also is a cross-sectional perspective view showing the structure of a spot light source provided with a single LED element and a reflective lens. The spot light source 6 shown in FIG. 6 is also provided with a reflective lens, 39, but is different from the spot light source 5 in that the reflective lens 39 also serves as a front glass. For this reason, the reflective lens 39 is fixed to the metal part 14. The reflective lens 39 also guides a portion of the light emitted by the LED element 18b to the side wall portion 12b, and forms leak light.

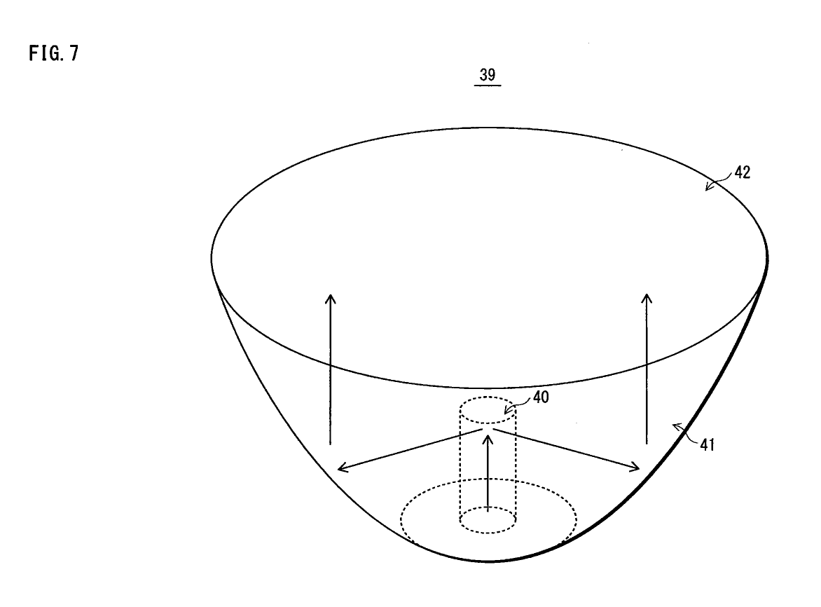

FIG. 7 is perspective view showing the appearance of a reflective lens 39. The light emitted by the LED element 18b is first reflected off a first reflection surface 40, is next reflected off a second reflection surface 41, which is cup-shaped, and is then emitted from a light-emission surface 42 on the front side of the spot light source 7. The reflective lens 38 has a similar shape.

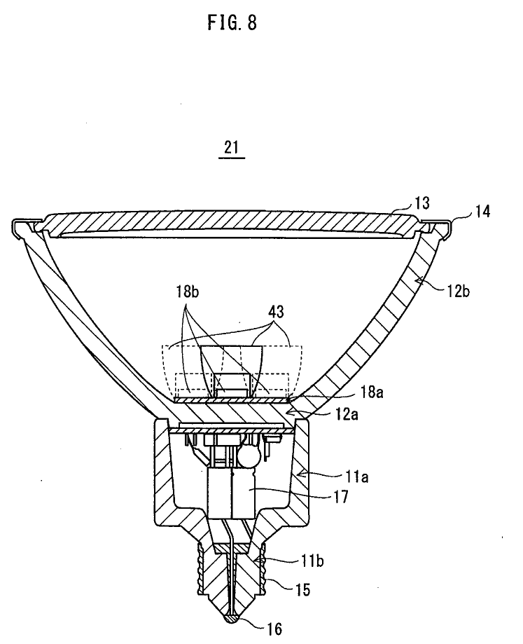

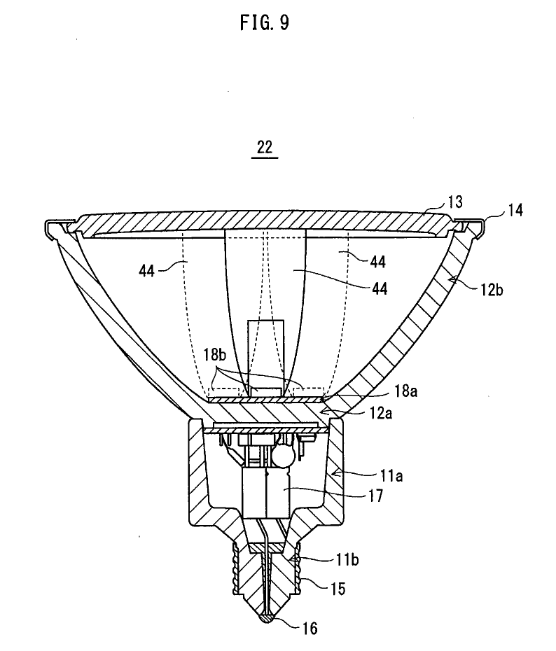

FIGS. 8 and 9 are cross-sectional perspective views each showing the structure of a spot light source provided with three LED elements and three reflective lenses. The spot light source 19 shown in FIG. 8 is provided with one reflective lens 43 for every three LED elements 18b. In the spot light source 20 shown in FIG. 9, each reflective lens 44 provided for every three LED elements 18b is integrated with the front glass 13.

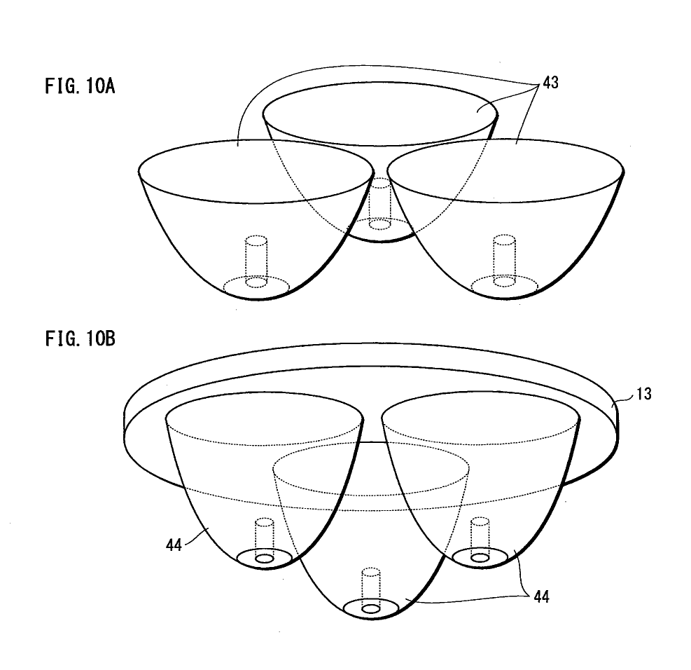

FIGS. 10A and 10B are perspective views showing the appearances of reflective lenses 43 and 44, FIG. 10A showing the reflective lens 43, and FIG. 10B showing the reflective lens 44. As shown in FIG. 10, each of the reflective lenses 43 and 44 is provided with a first reflective surface and a second reflective surface in the same manner as the reflective lens 39. In particular, the reflective lens 44 is fixed with a metal part 14 that is attached to the front glass 13 integrated with the reflective lens 44.

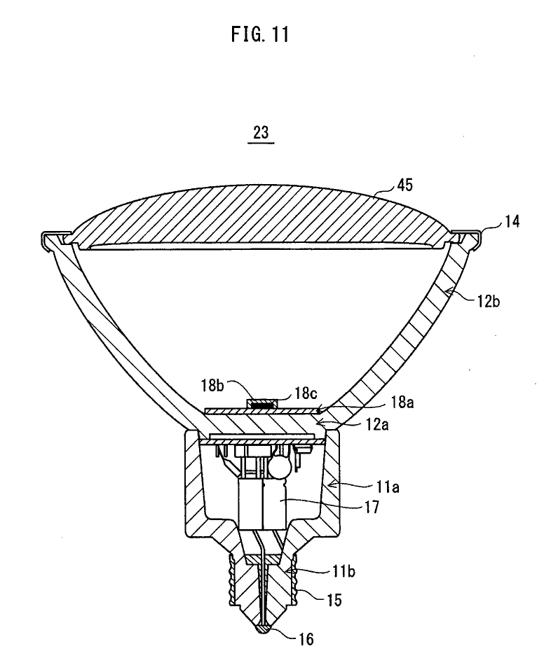

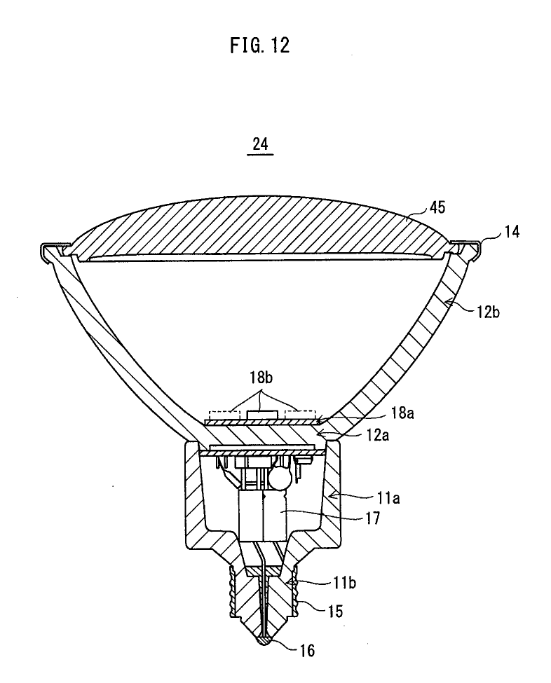

FIG. 11 and FIG. 12 are both cross-sectional perspective views each showing the structure of a spot light source provided with a convex lens. FIG. 11 shows a structure provided with a single LED element, and FIG. 12 shows a structure provided with three LED elements. In both cases, the light emitted by the LED element 18b is mainly collected in the direction toward the front side of the spot light sources 22 and 23 by the convex lens 45, but a portion of the light passes through the side wall portion 12b.

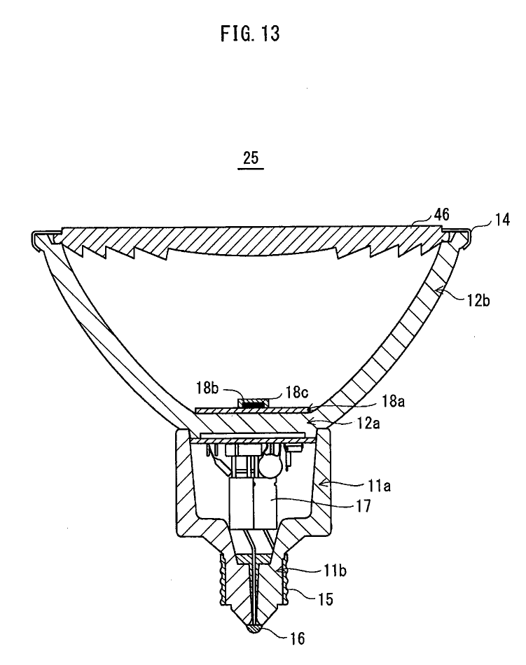

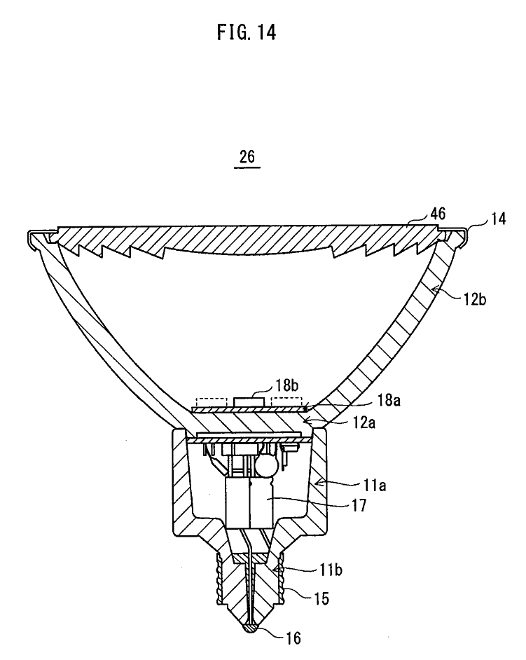

FIG. 13 and FIG. 14 are both cross-sectional perspective views each showing the structure of a spot light source provided with a Fresnel lens. FIG. 13 shows a structure provided with a single LED element, and FIG. 14 shows a structure provided with three LED elements. In both cases, the light emitted by the LED element 18b is mainly collected in the direction toward the front side of the spot light sources 24 and 25 by the Fresnel 46, but a portion of the light passes through the side wall portion 12b, which produces decorative effect.

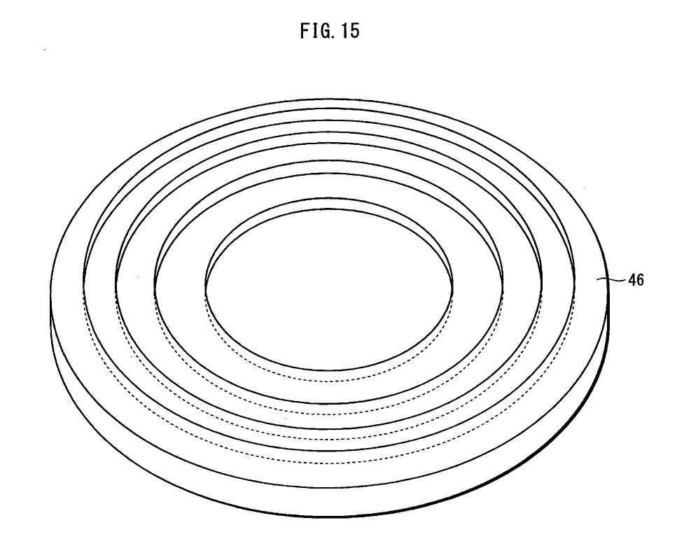

FIG. 15 is a perspective view showing the appearance of the Fresnel lens 46. As shown in FIG. 15, the Fresnel lens 46 is flatter than convex lenses, but achieves a similar light-gathering power. Thus, it helps to downsize a spot light source.

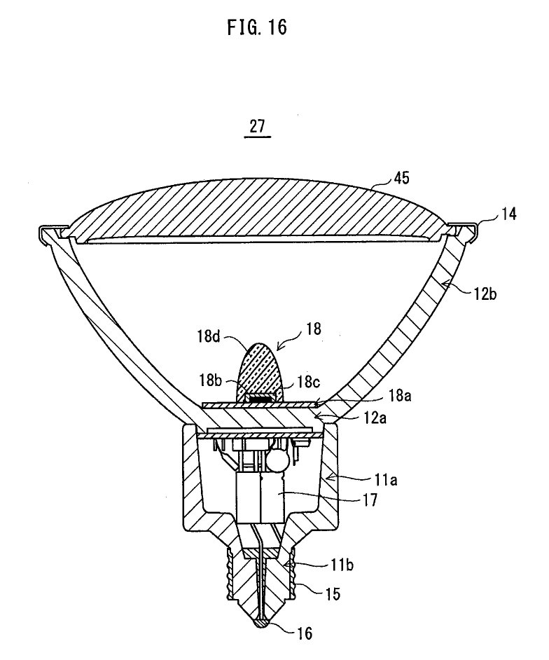

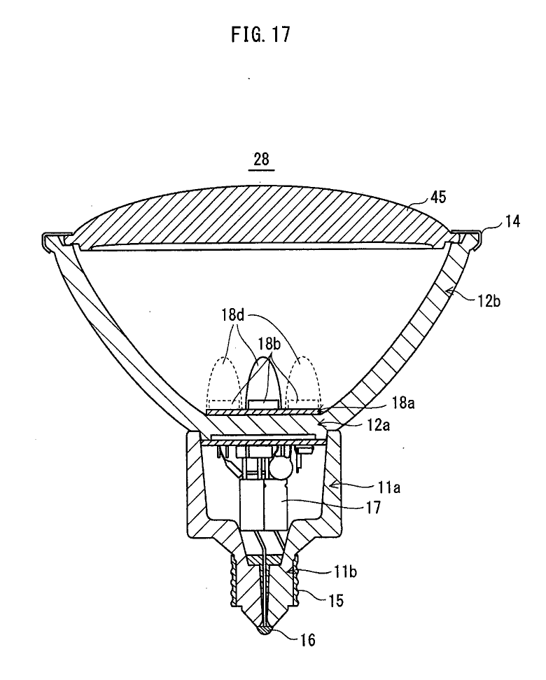

FIG. 16 and FIG. 17 are cross-sectional perspective views each showing the structure of a spot light source provided with the combination of a cannonball-shaped lens and a convex lens. FIG. 16 shows a structure provided with a single LED element, and FIG. 17 shows a structure provided with three LED elements. When the cannonball-shaped lens 18d and the convex lens 45 is used in combination, the light-gathering power of the cannonball-shaped lens 18d decreases and accordingly the amount of the light traveling toward the side wall portion 12b increases, whereas the convex lens 45 increases the light-gathering power in the direction toward the front side of the spot light sources 27 and 28. Consequently, such a combination achieves both high decorative effect and high light-gathering power.

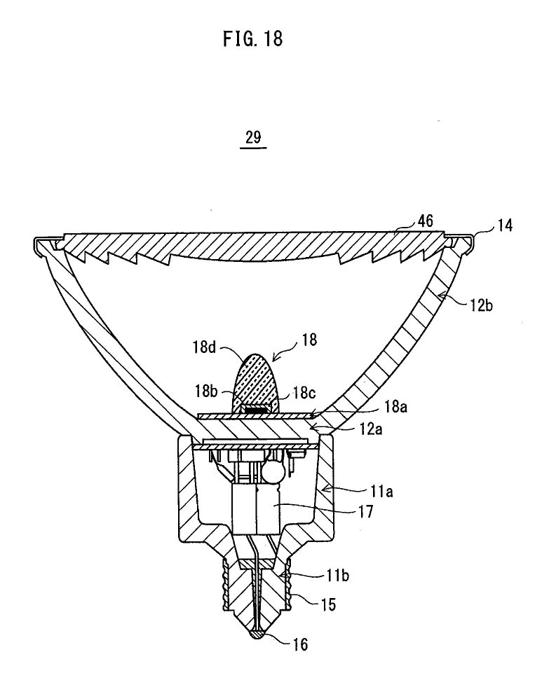

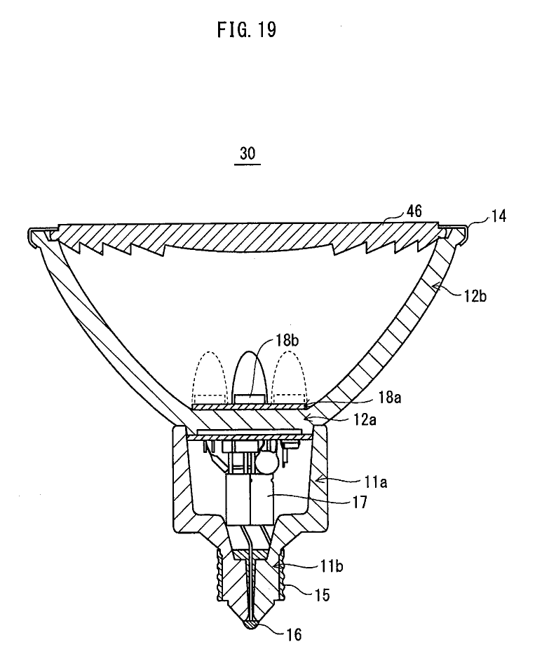

FIG. 18 and FIG. 19 are cross-sectional perspective views each showing the structure of a spot light source provided with the combination of a cannonball-shaped lens and a Fresnel lens. FIG. 18 shows a structure provided with a single LED element, and FIG. 19 shows a structure provided with three LED elements. Similarly to the spot light sources 27 and 28, the combination of the cannonball-shaped lens 18d and the convex lens 45 achieves both high decorative effect and high light-gathering power, and further helps to downsize the spot light sources 29 and 30 to be smaller than spot light source 27 and 28.

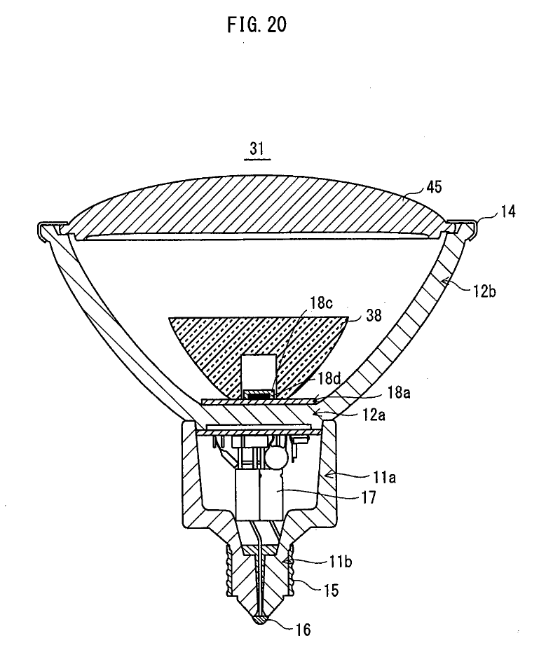

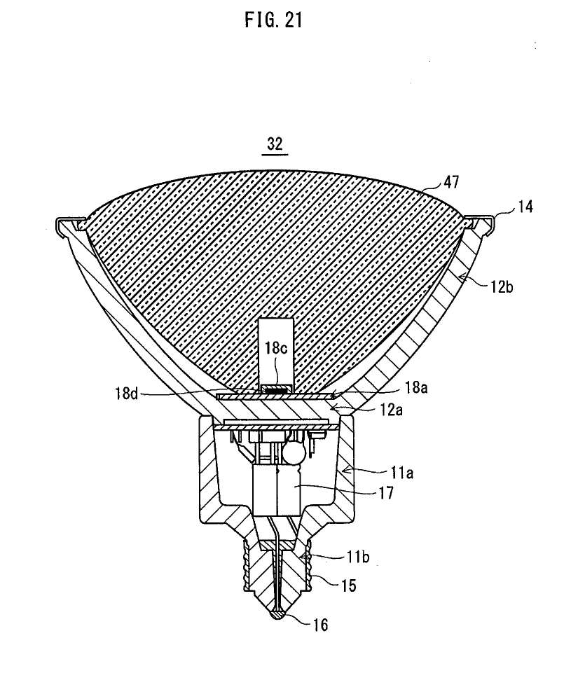

FIG. 20 and FIG. 21 are cross-sectional perspective views each showing the structure of a spot light source provided with the combination of a reflective lens and a convex lens. FIG. 20 shows a structure in which the reflective lens and the convex lens are separately provided, and FIG. 21 shows a structure in which the reflective lens and the convex lens are integrated. Similarly to the spot light sources 27 and 28, the combination of the reflective lens and the convex lens achieves both high decorative effect and high light-gathering power. Moreover, integrating the reflective lens with the convex lens reduces the number of the parts of the spot light source, and reduces the number of man-hours needed to manufacture the spot light source. This reduces the manufacturing cost.

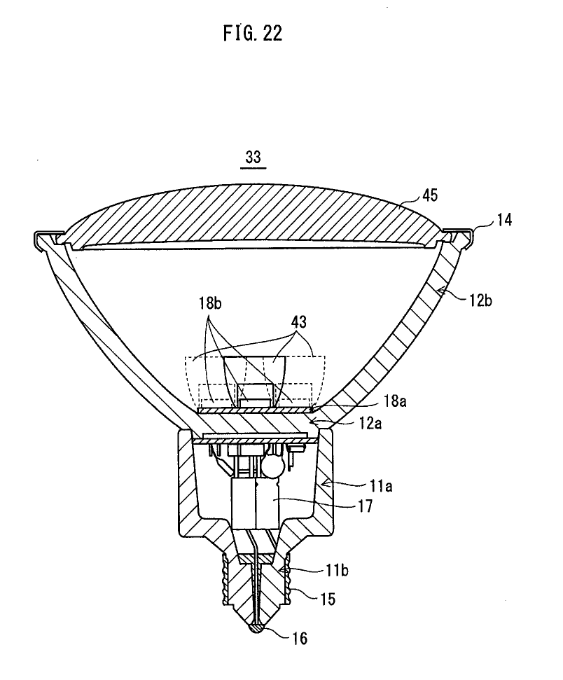

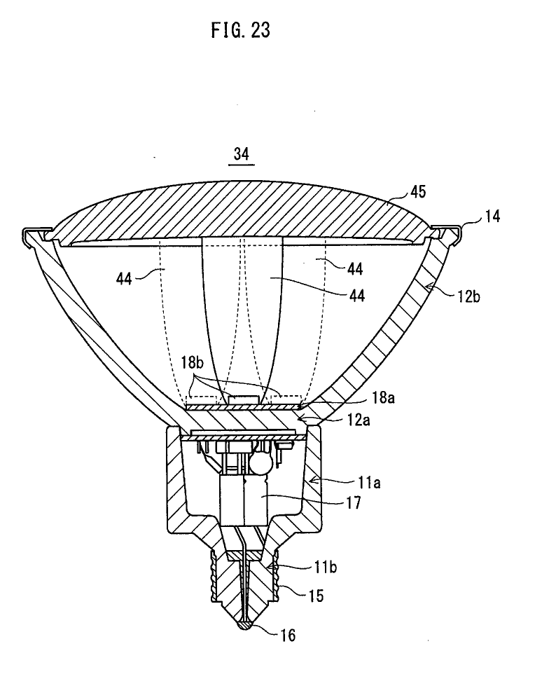

FIG. 22 and FIG. 23 are cross-sectional perspective views each showing the structure of a spot light source provided with three LED elements and the combination of a reflective lens and a convex lens. FIG. 22 shows a structure in which the reflective lens and the convex lens are separately provided, and FIG. 23 shows a structure in which the reflective lens and the convex lens are integrated. The increased number of LED elements as described above increases the amount of light to be greater than the spot light sources 31 and 32.

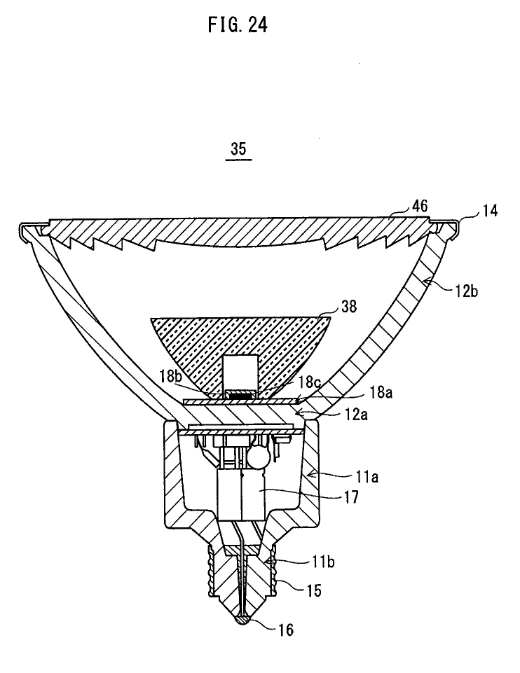

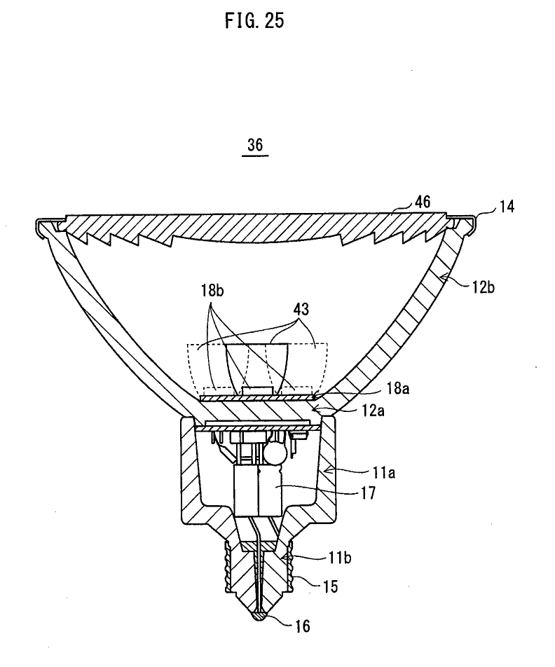

FIG. 24 and FIG. 25 are cross-sectional perspective views each showing the structure of a spot light source provided with a reflective lens and a Fresnel lens. FIG. 24 shows a structure provided with a single LED element, and FIG. 25 shows a structure provided with three LED elements. Such structures help to downsize the spot light source to be smaller than spot light sources 33 and 34 even when a reflective lens is used.

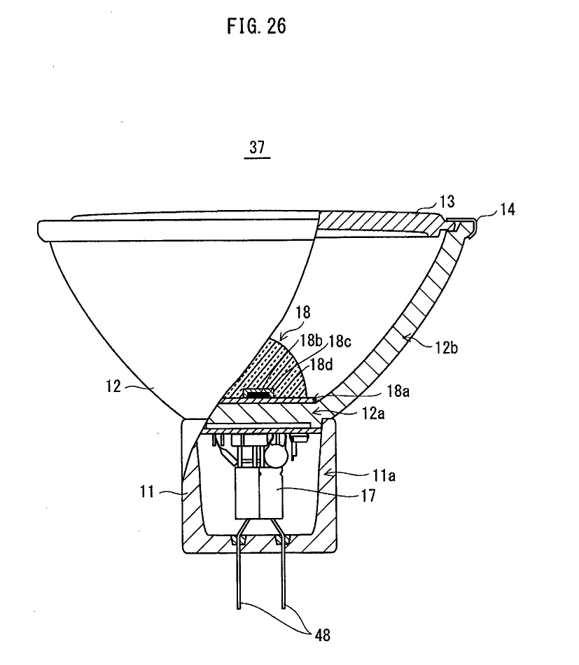

(2) Although not particularly mentioned above, the embodiment described above is provided with E type base. However, the present invention is not limited to this, as a matter of course. Bases other than E type bases may be used. For example, as shown in the partially cutaway view in FIG. 26, the same advantageous effects can be achieved even when a pin base is adopted in the spot light source pertaining to the present invention.

(3) In the embodiment described above, the side wall portion 12b is cup-shaped with a smooth surface. However, the present invention is not limited to this, and other shapes may be adopted. For example, many flat surfaces like facets may be provided on the side wall portion 12b at different angles, or concavity and convexity may be provided in the surface of the side wall portion 12b. Also, by forming the side wall portion 12b to have a rough external circumferential surface, it will be easy to apply silicon carbide or the like to the surface.

(4) In the embodiment described above, the entire circumferential surface of the side wall portion 12b is light-transmissive. However, as a matter of course, the present invention is not limited to this structure, and only a section along the circumferential direction may be light-transmissive. Such a structure increases the amount of light emitted from the section, and improves the decorative effect. This structure is particularly effective when a pin base is used, since the spot light source 1 attached to the fixture faces in a fixed direction.

(5) In the embodiment described above, LED elements are used as light-emitting elements. However, the present invention is not limited this. For example, organic EL elements may be used.

(6) In the embodiment above, a metal part 14 is used for attaching the front glass 13 to the opening of the heat radiator 12. However, the present invention is not limited to this. For example, adhesive agent or a screw may be used instead of metal part, in order to fix the front glass 13.

Also, the front glass 13 may be made of resin, glass or the like, and may be subject to frosting for adjustment of the light distribution of the spot light source.

(7) The embodiment described above is equipped with an optical controller such as a lens. However, the present invention is not limited to this, as a matter of course. For example, when ceramic containing rare earth elements in the polycrystalline state is used for forming the side wall portion, the color of the side wall portion changes depending on whether the light is on or off, and achieves highly decorative effect, regardless of the presence of an optical controller.

### INDUSTRIAL APPLICABILITY

The present invention is applicable to a spot light source which replaces a halogen light bulb with a reflection mirror.

### REFERENCE SIGNS LIST

1, 5, 6, 8, 9, 11-14, 27-37 . . . spot light source
11 . . . case
11a . . . cylindrical portion
11a . . . protruding portion
12 . . . heat radiator
12a . . . bottom portion
12a . . . side wall portion
13 . . . front glass
14 . . . metal part
15 . . . shell
16 . . . eyelet
17 . . . lighting circuit
18 . . . light-emitter
18a . . . metal substrate
18a . . . LED element
18c . . . silicone resin member
18d . . . lens
38, 39, 43, 44 . . . reflective lens
40, 41 . . . reflection surface
42 . . . light-emission surface
45 . . . convex lens
46 . . . Fresnel lens
47 . . . lens
48 . . . power supply terminal

1. A spot light source that serves as a substitute for a halogen light bulb having a reflection mirror, comprising:
a heat radiator being bowl-shaped and including a bottom portion and a side wall portion;
a light-emitting element provided within the heat radiator on the bottom portion;
an optical controller controlling light emitted by the light-emitting element;
a case having a built-in circuit for lighting the light-emitting element; and
a base supplying power to the built-in circuit, wherein
the optical controller guides a portion of the light emitted by the light-emitting element to the side wall portion, and
the side wall portion is light-transmissive.

2. The spot light source of claim 1, wherein
the side wall portion is made of ceramic.

3. The spot light source of claim 2, wherein
the ceramic contains primarily one or more constituents selected from the group consisting of silicon carbide, aluminum nitride, sapphire, alumina, beryllia, titania, yttria, silicon nitride, boron nitride, zirconia, magnesia and silica.

4. The spot light source of claim 1, wherein
the side wall portion contains a rare earth element in a polycrystalline state, and changes a color of the light from the light-emitting element.

5. The spot light source of claim 2, wherein
a silicon carbide film is formed on an external circumferential surface of the side wall portion.

6. The spot light source of claim 1, wherein
the side wall portion is made of a resin material.

7. The spot light source of claim 1, wherein
the bottom portion and the side wall portion are integrated in one piece.

8. A bulb-type light source that serves as a substitute for a halogen light bulb having a reflection mirror, comprising:
a heat radiator being bowl-shaped and including a bottom portion and a side wall portion;
a light-emitting element provided within the heat radiator on the bottom portion;
an optical controller controlling light emitted by the light-emitting element;
a case having a built-in circuit for lighting the light-emitting element; and
a base supplying power to the built-in circuit, wherein
the optical controller guides a portion of the light emitted by the light-emitting element to the side wall portion, and
the side wall portion is made of ceramic containing a rare earth element in a polycrystalline state, and changes a color of the light from the light-emitting element.

9. The bulb-type light source of claim 8, wherein
the ceramic contains primarily one or more constituents selected from the group consisting of silicon carbide, aluminum nitride, sapphire, alumina, beryllia, titania, yttria, silicon nitride, boron nitride, zirconia, magnesia and silica.
